(19) United States
(12) Patent Application Publication
(10) Pub. No.: US 2009/0014026 A1
(43) Pub. Date: Jan. 15, 2009

(54) Thin Film Interdental Cleaning Device with Flexible Folds

(76) Inventor: Rory Powell Blake, Charlotte, NC (US)

Correspondence Address: Rory Blake, 3216 Chaucer Drive, Charlotte, NC, 28210, US

(21) Appl. No.: 12/169,649

(22) Filed: Jul. 9, 2008

Related U.S. Application Data
(60) Provisional application No. 60/958,900, filed on Jul. 10, 2007.

(51) Int. Cl. A61C 15/04

(52) U.S. Cl. 132/329

(57) ABSTRACT

A proportionally wide strip of very thin and flexible material which is specially treated by mechanical, chemical or other means to form a multiplicity of folds, pleats, or channels along it's longitudinal axis and which is further intended to be pulled or drawn between teeth and along the gum line adjoining said teeth as an aid in the removal of trapped food particles and for the daily cleaning and removal of the build-up of plaque from these interdental areas; said device being further intended to spread, to roll-up onto, or to collapse upon itself by the means of increased or decreased pressure from external pulling force or from being drawn through the narrowed spaces between teeth; said ability to collapse and to roll upon itself is at once a better method to displace and/or to trap and contain bacteria, food particles, and other debris to be removed but also as a means to maintain contact with these surfaces while accomodating the variable spacing between teeth and between teeth and gums that is found in a normal mouth.

### BACKGROUND OF THE INVENTION

1. Field of the Invention

The general field of this invention relates to dental cleaning and more particularly to dental floss, which is used to remove particles of food from between the teeth and also as an aid to removing the daily build-up of plaque from the teeth and gums before it hardens into tartar.

2. General Backgound

Since before recorded time, individuals have used filimented, spun or flaxen threads and string in attempt to remove large food particles that have become trapped between their teeth. That basic tool of string as floss and the technique (flossing) for cleaning between teeth has changed very little since those earlier times. The first United States patent relating to dental floss was issued in 1874 to Asahel M. Shurtleff of the dental supply company Codman & Shurtleff, of Randolph, Mass. It described “An Improved Pocket Thread Carrier and Cutter.” This embodiment is not much different from today's standard packages of floss.

Commercially available dental floss products based on this early and primative model have not changed much in the many years, either. Today, the act of flossing is still done in much the same way it always has been. Flossing is still accomplished by placing a strand of floss between adjacent tooth surfaces and moving it backward and forward (and up and down) between that tooth pair, one pair at a time.

It is widely and generally held, today, that . . . as “standard” floss worked well then, it must still work very well . . . even though, today, millions avoid using it. The conventional wisdom is . . . if you have problems with floss or with flossing, it must be you that has the problem.

Luckily, the inventors in the United States generally ignore “conventional wisdom.” Since 1975 more than 1,300 U.S. patents have been issued for changes or improvements in floss and floss peripherals. Remarkablely, the state of the art in dental floss has remained in this traditional “string-based” model for well over a hundred years. Many patents have been granted, yet, few go beyond becoming “improvements” to the traditional string model. Further, although many have been attempted, most sucessful improvements were usually minor changes or additions to that traditional concept of floss and flossing. None of this prior art has anticipated the embodiment of an entirely different flossing model . . . although methods, materials and processes have all been improved over time. Except for the current embodiment and a handfull of others, there is little art in this field which considers other than woven, spun, flaxen or monofiliments in the basic “sting style” for flossing use.

Few of us are willing to totally abandon all of that which has come before. Therefore, it is completely understandable that most prior inventors simply accepted the basic “floss as string” model, the dental floss “status quo,” and then attempt to improve upon that. Examples of “improvement” from a United States Patent Office search include surface coatings such as waxes to lessen friction . . . and others surfaces treated to increase their grip (and also their friction.) There are examples of threads of all descriptions . . . woven into a wider “tape” to increase the surface area of cleaning. Further, there are examples of a thread made much finer to better get between more closely spaced teeth. Many equally interesting variations exist. They have one thing in common; each “new” embodiment will look similar to, and indeed, performs physically very much like the “old” one.

The current embodiment begins at a much more basic level than “string” as dental floss. It begins where all inventions need to begin: with an examination of need. As human animals, we all must eat. As a result, we can all get food particles caught between teeth. The large food particle, trapped between teeth, is still a primary impetus for dental floss use. Most non-regular floss users will only reach for floss when this occurs. Unremoved, most know that a bothersome food particle tapped between teeth will eventually decay and that it can cause bad breath, dental carries, the abcess of gums and other gum disease.

As social animals, a pretty smile and the prevention of mouth odor, by themselves, may be good enough reasons to floss. People who want to look and smell their best generally already include flossing in their daily hygine. However, many more Americans do not.

Flossing is certainly avoided because it is time consuming and hard-to-do correctly. However, it is equally likely that flossing is avoided due to fear of pain. This fear of pain is justified. Pain can occur even from the CAREFUL use of the current flossing tools. Hasty usage of regular dental floss almost certainly causes bleeding . . . and can hurt or seriously damage sensitive gums. Even EXTREMELY careful flossing with today's tools occasionally will abrade the gums and cause pain. Further, as flossing progresses into the more delicate sulcular interdental areas nearest the gum line—the risk of damage becomes much more likely. Accidently rubbing or pulling the strand against the gums, especially in this area, is very often the cause of pain and bleeding.

Regular dental floss has been such an accepted product for such a long time that society generally views those who avoid flossing—as either being overly fearful or overly lazy. This view is unfair, as the design of the tool, itself, may be to blame. For this reason, alone, the quest to make further improvements in traditional flossing becomes warranted. However, this is not the motivation behind the present invention. There is another, much more important, reason to improve traditional flossing: the health of the body as a whole.

An increasing number of studies have linked poor oral hygine to a growing number of other substantial medical conditions, such as, a confirmed link to heart disease. These studies show that a healthly body begins with healthy teeth and gums. Maintainance of the health of the entire physical body is an important reason to care for the teeth and gums. The reason for preventive dental care is simple. Each day a film-like coating of plaque develops on the teeth and on the surrounding gums.

Brushing readily removes this from the teeth and gums on all but the interproximal dental surfaces where the bristles of a toothbrush cannot easily reach. Left unremoved, for just one day, this remaining plaque can harden into tartar which promotes periodontitis and tooth decay. Daily care of just the teeth may not be enough, either, because flossing of the teeth does not remove the plaque that also forms daily on the gums.

Moreover, less than careful flossing with today's tools can also be of high risk to the heart. Even dental care professionals can put the health of our hearts at risk. Deep cleanings with today's current generation of flossing products can easily damage the interdental papilla and often dislodge bacteria into the bloodstream. There is a confirmed link between this gum damage and heart disease. Bacteria originating from the gums and mouth is seen in arterial disease, can colonize on heart tissue, and destroy the normal functioning of heart valves.

Daily flossing is clearly indicated to protect the health of the body as a whole. Further, a need for improvement exists both in the daily removal of plaque and debris, as well as, in the removal of the occasional larger food particles that become caught between teeth.

### Discussion of the Prior Art

U.S. Pat. No. 3,860,013 issued on Jan. 14, 1975 to Henry Czapor for a dental strip discloses a dental strip of a rubber like material having a handle means and a thin stretchable section therebetween for introduction between the teeth for cleaning thereof. Claim 1 was for “A dental strip comprising a cleaning section of flexible and stretchable elastic material.”

U.S. Pat. No. 4,776,358 issued on Oct. 11, 1988 to Leonard Lorch disclose in the Abstract “The flossing material in the form of a tape is formed of expanded polytetrafluoroethyline (PTFE) folded longitudinally to form a pair of laminae defining a recess there between in which an abrasive or non-abrasive cleaning material is disposed.

U.S. Pat. No. 5,293,886 issued on Mar. 15, 1994 to Henry Czapor discloses an improved dental strip made by reverse die cutting of a latex rubber tube.

U.S. Pat. No. 5,479,952 issued on Jan. 2, 1996 to Anagnostis E. Zacharides discloses in claim 1. “A dental floss comprised of a unitary filament of high molecular weight polyethylene material having a molecular weight of at least 300,000” and in claim 3. “The dental floss as described in claim 1 in the form of a tape having a width in the range of 0.01 to 0.25 inches and a thickness in the range of 0.001 to 0.005 inches.”

U.S. Pat. No. 6,003,525 issued on Dec. 21, 1999 to Harry S. Katz discloses in claim 1. “A dental floss comprising a filament of elastomeric material having serrated edges throughout a given length and initial cross section that is stretchable to a reduced cross-section so as to fit between the teeth of a user” and in claim 2. “The filament of claim 1 having a cylindrical cross section.”

U.S. Pat. No. 6,161,555 issued on Dec. 19, 2000 to John Young-Fu Chen discloses “A novel dental floss and gum massager made in the form of a strand, a tape or a sheet of polymeric maerial, said sheet having selectively positioned multiple sized holes for inserting through and holding by the fingers of the hands.”

U.S. Pat. No. 6,192,896 issued on Feb. 27, 2001 to Belinda L. Tsao, et al. discloses in Claim 1. “A method of producing an elastomeric floss.”

U.S. Pat. No. 6,607,000 issued on Aug. 19, 2003 to Padma Marwah and Ashok Kumar Marwah discloses from the Abstract “A frilly dental floss formed of thin wide ribbon with frilly edge(s) or centrally located slits or the combination thereof, made from a strong, naturally waxy, polymer material preferably from a biodegradable, thin-gauged high-density polyethylene (HDPE) material.

U.S. Pat. No. 7,025,986 issued on Apr. 11, 2006 to Dale G. Brown et al. discloses in the Abstract “A shred resistant, ultra-high molecular weight polyethylene micromesh interproximal device produced by fibrillating and slitting stretched polyethylene film”

Each of these patents is referenced because they are among the few in the prior art which are not based upon a traditional use of “a fiber” or “a filament” as dental floss. Several of the above disclose a “tape like” structure somewhere in their disclosure. Many disclose usage of polymers such as a high-density (HDPE) polyethylene. One patent (Loarch) discloses a tape with a single fold. However the Loarch patent also discloses completely filling the area inside of this fold with an abrasive or a dental paste and the insertion of it between the teeth in the folded manner.

There are few disclosures in all of the prior art which even mention the value of basic scientific observation of the mechanical act and nature of flossing, much less suggest a study of the gross morphology of the structures of the mouth. Most of the prior art simply focuses on product design while ignoring the structural physiology. No prior art actually deals directly with the large differences of tooth and gum structure.

### Statement of Need

Tooth and gum physiology and even the normal uneven alignment of teeth in the mouth are largely unaccounted for in the prior art. The neglect of something as basic as physiology—illustrates a primary need for further study to develop new products and technique. The structures of the mouth are fundamental to the principles relating to the present invention. The close interface, in real life, between the teeth and the gums does make it harder to design a product that can clean both the hard surfaces of the tooth, as well as, the much more tender gum tissue,—and at the same time. This deficency has long needed to be addressed. It is addressed in the current embodiment.

To some degree, each of the differing interproximal areas found in the mouth exhibit this non-uniform physical morphology. There are not only differences in hardness, degree of tenderness, and composition of the individual surfaces that need to be taken into account but there are also differences in the size, shape and topiography of each of the areas needing to be cleaned.

All previous dental floss designs are rigid or semi-rigid in at least two of the three dimensions, and most are more or less uniform in dimensional and cross-sectional structure. The interproximal and interdental areas, themselves, are anything but uniform. Additionally, all of the prior art on dental floss, all of it, simply ignores or glosses over the area of the gums. Other prior art for gum stimulators does exist. However, they each deal with cleaning of the gums seperately. Further, a search was unable to find prior art dealing, except exclusively, with large particle removal from between teeth.

No prior art exist that can sucessfully clean between teeth and gums and that also can be used to remove objects caught between teeth, while also being gentle on the gums. That this deficency still exists is possibly because almost all of the entire body of prior art dealing with interdental and interproximal cleaning and debridement appears to have been built on continuing to do that which has appeared to have worked in the past. Since a “string” form has worked in the past, virtually every new innovation also seems based soley on improving the performance of string.

Further, little of the prior art appears to have been developed completely “from scratch” or, in the least, started with a completely clean sheet of paper. Even less of the prior art incorporate what could be called completely new and fresh design. Most simply appear the continuation of that which has gone before, and then modified. None goes back to the basics of deciding just-what-it-is that needs to be accomplished, and moves forward from there. Most of the real improvement in the area of floss and interdental cleaning has come because of a technological advancement in another area which could quickly and easily be translated into an improvement in this one.

### SUMMARY OF THE INVENTION

### Objects of the Invention

The encompassing object of the principles relating to the present invention is the provision of an effective flossing method and device, the device possessing a thin film structure that shall easily and safely conform to the anatomical structure of the areas between the teeth and between the teeth and gums while further possessing a plurality of folds or pleats along the length of the device, said folds or pleats having the ability to roll, to expand, and/or to contract within said space-enabling the maintanance of contact sufficent for cleaning and debridement of these surfaces as the device is drawn through this area.

A first auxiliary object of the principles relating to the present invention is the provision of a flossing device possessing a thin film structure with hydrophillic, or water holding properties, which when wetted and dawn between the teeth—displaces said water such that said film rides within a cushion of water and provides to the surrounding surfaces the equivalent of a high speed stream of water of sufficient velocity for cleaning.

A first ancillary object of the principles relating to the present invention is the provision of a flossing device possessing a thin film structure with hydrophillic properties while further possessing a plurality of folds or pleats along the length of the device, said folds or pleats when wetted and pulled through interdental spaces have the ability to roll, expand, and contract within this cushion of water and whereby enable contact sufficent for cleaning and debridement of tooth or gum surfaces.

A second auxiliary object of the principles relating to the present invention is the provision of a flossing tool which possesses a thin film structure which includes a plurality of folds or pleats which are twisted along the entire length of said structure, said folds or pleats having the ability to roll up and or to close down upon themselves—thereby trapping and holding food particles (and other disease and odor causing debris commonly found in the areas) internally, as the tool is drawn along or within the interproximal space and interdental areas.

A second ancillary object of the principles relating to the present invention is the provision of an effective flossing tool which possesses a thin film structure that can easily and safely conform to the interproximal and interdental structures of the teeth and of the teeth and gums while further possessesing a structure which includes a plurality of folds or pleats along the length of the device, said folds or pleats having the ability to pinch or to fold upon themselves—thereby having the ability to remove larger trapped particles first by gripping, then dislodging, and continuing to hold tightly to these particles as the tool is first pulled along and then squeezed through or along said interproximal or interdental spaces.

A third auxiliary object of the principles relating to the present invention is the provision of an effective flossing tool which possesses a thin film structure that can easily conform to the interproximal structure of the teeth and gums while further possessesing a structure which includes a plurality of folds or pleats along the entire length of the device, said folds or pleats exhibiting an ability to thinly spread out or to collapse when pulled between the very tight spaces normally associated with narrow interdental areas—thereby displacing, dragging and/or grabbing and pulling along many food particles and other (disease and/or odor causing) debris commonly found within said interproximal and interdental areas.

### Principles Relating to the Present Invention

A point, by point, examination of the Physiology of the mouth, as it is involved in the cleaning and the removal of debris caught in the interproximal space, is considered fundamental to the principles relating to the present invention

Most of the dental flosses sold commerically, today, are filaments. Therefore, they to are limited by the gross physical and material structure of the “filament.” To explain; all filaments, in cross-section, are widest at their centers. FIG. 1

Filaments are, therefore, widest at the center of each strand—as viewed from the end of that strand. Rotating that stand makes no difference, as thread, string and all “like filaments” are round in cross-section. Said strand is relatively inflexible in cross-section; therefore rotating it will make no difference in it's cross-sectional dimension. Only a single point along the surface of the strand—one which is directly adjacent to the tooth surface, can be in contact with that tooth. Only one small point of the relatively large surface area of that strand can be in contact with any portion of the surface of the tooth—at any one time.

An easy analogy of this is the “patch” of a tire. The patch of a tire is the portion of a tire that remains “in contact” with the road. So, only a small amount of each tire is in contact with the road—at any given time. Because the tire, itself, is round and the road surface is flat, by the laws of physics very little physical contact could ever be available—at any one time.

When viewed in cross section, the circular nature of a filament-like the circular nature of the tire—is the limiting factor for contact. It is only the extreme anterior surface of the cross sectional area of each strand that actually contacts the surface of the tooth. This limited area of contact, additionally, assumes cylindrical contact with a flat surface. In nature, very little of a tooth surface is completely flat. Most of the actual tooth surface is, in fact, crowned. There can only be—much less of a physical contact between these two cylindrical structures. A cylindrical shape such as that of a filament and a peaked, equally convex and rounded surface such as a crown of a tooth can only barely touch, and then only at a single point.

Any pressure exerted on a taut strand of this floss is transferred to a single point along the opposite side of its cylindrical exterior surface. That “all” of this pressure is transferred to this one finely highly defined area is what makes strands of dental floss, useful as a cutting tool. In fact, many bakeries use dental floss to cut cakes. They find that dental floss slices freshly baked cake much more cleanly than does a knife. It is the basic structure, the filamented form, of traditional dental floss that limits both the contact area and the potential cleaning area. This is also what makes today's dental floss more prone to damage gums.

In a second major omission, little of the prior art seems to have fully taken into account the wide interproximal variences that naturally occur between the many adjacent pairs of normal teeth. Much of this normal variation is due to differences between the physical structures of each of the teeth in the pair, be they a molar paired with an incisor, or another pairing. There is not only a variation in spacing between pairs of teeth, there is also a wide variation in the spacing between the top and the bottom of that area located between any two adjacent teeth. Further, this lower area of the interproximal space in a healthy mouth is largely taken up by gum tissue. Therefore, no real world discussion of cleaning between teeth can ignore the cleaning, massaging and safety of gum tissue.

Due to the physical structure of each individual tooth, the gap between a pair of adjacent teeth is much wider at the base, or lower portion of the pair than it is—further—up on the tooth surfaces. The separation between adjacent teeth is usually at its very least near the top center of the crown areas of any pair of teeth. In a normal mouth, teeth are usually closest together at their crowns. The space between adjacent teeth continuely widens as it continues further down the neck and onto the bases of that tooth pair. Most of this wider spacing is taken up by the gums, the sulcus, in a healthy mouth. The individual alignment of each adjacent tooth pair in the mouth is seldom uniform, teeth are never exactly the same distance apart, nor are they at exactly the same angles from one another.

A few inventors have proposed multi-stranded floss and other methods to address some of this natural variation in tooth spacing. A floss composed of a filament or even bundles of filaments cannot possibly be configured to exactly fill every gap between every pair of every set of teeth. Fibers and filaments are essentially rigid structures. They are not flexible enough in cross-section to configure to and or to flex nearly as much as would be required. A rigid cylindrical shape cannot contract or expand to fit into, or to fill this varible space between teeth.

Due to these problems with traditional and multi-stranded flosses, there have been efforts made to prepare a new generation of flossing products. These flosses are of polymeric and elastomeric materials. Among other advantages, flosses prepared from such materials have the potential to assume a number of different thicknesses depending on the stress to which they are subjected, and therefore, can supposedly be tailored readily, by hand, to the individual user's individual tooth spacings and dental needs.

An interdental cleaning tool designed to precisely fit into, and designed to fill the gaps between teeth, and between teeth and gum could clean plaque from all surfaces in the interproximal space at the same time, has yet to be described. To work in this way; such a tool would have to bridge the wider gap at the base of a tooth pair yet fit between the narrowest of spaces around the crown. The prior art of polymeric elastomeric materials can approach this goal, but cannot do so, at least without extreme care. They can stretch, but cannot easily expand in a controlled, sufficent and consistant way without a having a constant, highly controlled, yet highly variable pressure being applied at that same time.

To be useful and effective such a device would, of course, also have to be easy to use. It, further, would have to be very gentle on the gum of this interproximal space. The highly elastic devices, such as elastomers, tend to pinch the guns as they rub against them. It would be highly desirable to have an interdental cleaning tool exactly fitting every space that were both easier to use and that would not pinch sensitive gums. The current disclosure is an interdental cleaning tool and method designed to precisely fit and fill the gaps between teeth, and between teeth and gum, as to painlessly clean plaque from all surfaces at the same time—even the gums, and in just one pass.

A third and futher consideration is for the occasional need of a tool to remove larger food particles which can become trapped between teeth. Ordinary floss does not do a good job of “gripping” food particles caught between teeth. Current floss product can only be used as a removal tool (to push or force)—when they are held taut. Use of a filamented floss in this way can often wedge a larger food particle more tightly into a space between the teeth. Increasing the pressure on this tautly held strand can, and often will, result in the floss inflicting damage to the adjacent gums.

Traditional floss does not pick material from between the teeth, nor can it simply grip food particles. As a point of fact, it is extremely hard to manuever “string” into an effective position to catch or hook a food particle caught between teeth. Another consideration, not addressed in prior art, is that food particles which can become caught between teeth are seldom of a uniform size or hardness. Even if traditional floss somehow has been made to do so in the past, it is just not very efficent in removing particles. This is just as a rope would never be as efficient as a pair of tongs would be in removing an object lodged in a crevice.

No prior art has described a method to get a tong-like gripping action into sufficient size to fit between teeth. An interdental cleaning product that can easily trap food particles of various sizes and consistancy, hold them, and pull them from between the teeth—is truly of need. A novel holding and gripping action, which is just what is needed, is described in the perferred embodiment of the principles of the current disclosure.

Fourth and finally, for good dental hygine, all of the plaque that is built up daily must also be removed, daily. Each gum and tooth surface, including under the sulcus and in the interproximal areas between the teeth need to be cleaned daily, as well.

Traditional floss is much too thick and way too abrasive for this use, very especially in the latter area. It can just too easily cause damage to the gums in these sensitive areas. Many of the embodiments described in the prior art are simply just too hard and also too unflexible. Almost any force exerted upon these examples can cut into sensitive gums. Further, because much of the interproximal space in a healthy mouth is almost fully taken up by the dental papilla, traditional toothbrushes, picks or even speciallized interproximal brush types cannot fully clean, or even completely reach into the more narrow interdental sulcular areas. The preferred embodiment of the current invention can safely remove the daily build-up of plaque from much of this hard to reach and sensitive area.

### BRIEF DESCRIPTION OF THE DRAWINGS

FIG. 1.) is a strand of “used” dental floss (nylon, monofiliment, or other) as seen in cross section. Compared this to a “used” version of the preferred embodiment of the current disclosure (FIG. 2 below) The traditional strand is very much fatter, much harder to maneuver and also has very much less total surface area to make contact with tooth surfaces

FIG. 2.) is a cross sectional view of various of the random folds of the current invention after being used and pulled through an interdental space (between the teeth) and illustrative of the amount of surface area available to debride and to trap debris

FIG. 3.) is a plain elevational view taken from the side (at an oblique angle) of the preferred embodiment of the principles relating to the present invention before being wetted and before being orally used

FIG. 4.) is a plain elevational view taken from the top of the preferred embodiment of the principles relating to the present invention while being pulled between a tooth pair

FIG. 5.) is a plain elevational view taken from the side of the preferred embodiment of the principles relating to the present invention being pulled between teeth

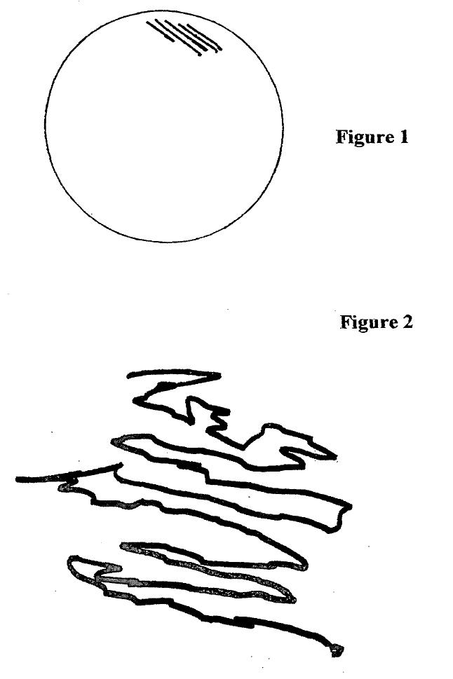

### DETAILED DESCRIPTION OF THE PREFERRED EMBODIMENT

A thin film interdental cleaning device with flexible folds, pleats, channels or formed risers and indentions as describes in accordance with the principles relating to the present invention as depicted in FIG. 2-5 as possessing a relatively and proportionally wide width, (in relation to the thickness) long in length, and further possessing a very thin film structure.

The perferred embodiment of the current disclosure differs from all prior art by the shape, contour, and form taken by the thin film device. The current disclosure involves an abrupt departure from prior art—in both the physical design of the device (the shape) and the method of use (or function) of the component.

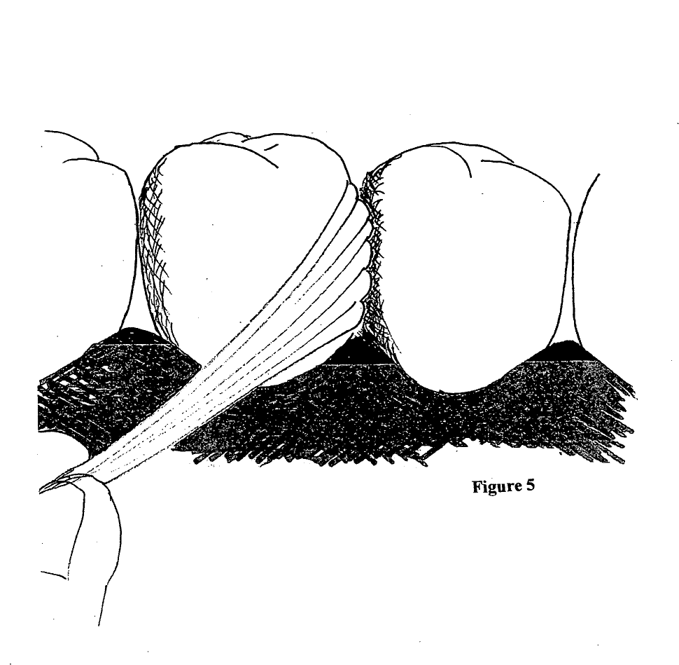

The preferred embodiment of the current disclosure is designed to be pulled between the teeth rather than be sawed back and forth, or moved up and down, as traditional floss is generally handled. FIG. 5 The preferred embodiment, as disclosed in the second auxiliary object of the principles relating to the present invention, is designed to trap particles and debris within the structure of the device while being drawn through the interdental space. It would not make sense to draw these debris back into the interdental space by using a technique of back and forth motion as is traditionally done when flossing. The perferred embodiment of the present invention begins with a thin film of a range of thicknesses from 0.0005 to 0.005 inches, or more, before coatings are applied.

This film in each case is formed by extrusion or other method and rolled unto a cylinder for further processing. The film is then unrolled and sliced into approximately ½ inch strips before being further processed through another rolling device which mechanically shapes and creates the multiple rounded pleats, creased rolled form, or stacked rounded folding of the final shape. This folding may be created and/or enhanced by other means. The end result of this processing is a flexible and thin film folded multiple times along it's length.

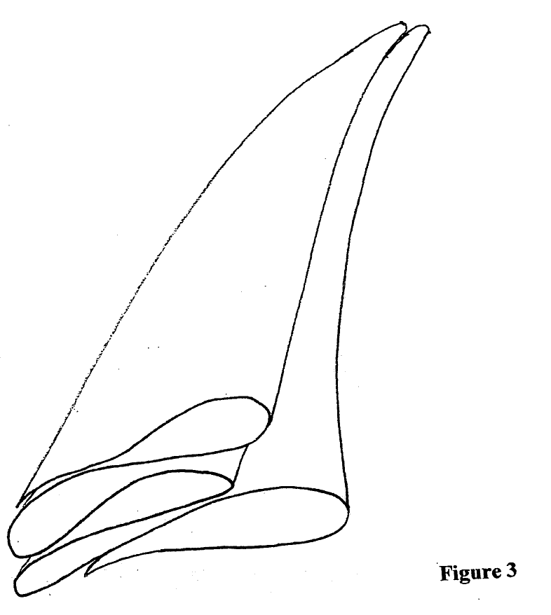

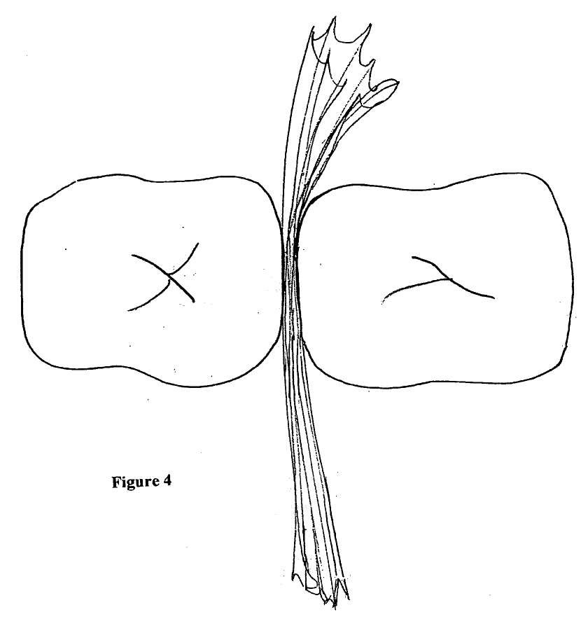

In cross section, the resulting preferred embodiment of a thin film interdental cleaning device is highly folded and quite varible in the ultimate shape that it can take or assume while it is being used. FIG. 2 As a finished product, the preferred embodiment will be much more bulky and much harder to store than it would be as a flat film. FIG. 3 The packaging of the preferred embodiment may be supplied to the consumer in two ways, in a traditional roll form or in form pre-sliced into twelve to eighteen inch strips.

The preferred embodiment works well as a debridement tool because it has been folded to expand in volume and therefore can present a surface area great enough to make contact with the outer edges of any small space that it is to be pulled through. FIG. 2 The preferred embodiment further is made up of a thin film, so that it may contract to a much smaller surface area if it is, again, forced to do so. FIG. 4

As the preferred embodiment is designed to be pulled through the interdental areas, rather than moved back and forth inside them, almost the entire length of the device has at least some chance to interact with the interdental substrate

With the outer edges of that interdental area as it is being pulled though. By rolling, expanding, and sliding its way though a narrow channel, it debrides plaque and other debris from within and also from the margins of the involved space. FIG. 5 In the preferred embodiment, this rolling and sliding effect may further be enhanced by wetting the film before using it.

There are various forms of polymer substances available in extruded sheet form which could easily be made to work according to the principles relating to the present invention and outlined in this application. They include, but are not limited to, High density polyethylene (HDPE) and various forms of processed ultra-high molecular weight polyethylene (UHMWPE) and others in oriented and unoriented films.

The principles relating to the present invention are not dependent on a single or a limited number of materials being selected for the manufacture of the preferred embodiment. This differs from most of the prior art. A singular material disclosed in the prior art is essential to the production of the preferred embodiment of many of the referenced disclosures. In fact, the change of material to be used to manufacture the flossing product is the basis of most of the referenced patents. In this disclosure, many materials made with various degrees of tensile strengths and wide ranges of cross-linked and orientation structures can and may be used in the manufacture of a preferred embodiment of the current disclosure.

Further, and in accordance with the principles relating to this invention, some films described in the referenced prior art would be unacceptable for a preferred embodiment of this invention. A film used for the preferred embodiment of the current disclosure would primarily differ from the cut latex film interdental device and other referenced disclosures that depend on elasticity.

The preferred embodiment of the current invention is flexible, but is also essentially non-elastic in its physical nature. In the preferred embodiment of the current disclosure, a thin and flexible material, optimally shaped to present the maximum amount of surface area possible, is much more important than any gain from elasticity as was relied upon in the prior art in the attempt to increase flexibility or to change the thickness of the material by the coordinated increase or decrease of the pressure applied to it.

It should be noted that some forms of film interdental devices are not disclosed in the prior art. For example, for use by dentists, there are available various forms of woven monoplanar tapes which can be manually coated with various grades of abrasives, coatings, and other polishing materials; and used interdentally to complete a professional cleaning procedure. The preferred embodiment of the current disclosure may, likewise, be pulled tightly against one tooth surface between a tooth pair to polish or to clean that individual tooth surface. However, in the preferred embodiment of the current disclosure the rolling folds and pleats simply collapse upon themselves to make full contact with the tooth surface.

In summary, the preferred embodiment of the current disclosure differs in both function and design from all prior art. The principles relating to the present invention require it to be pulled along and through interdental spaces rather than moved back and forth as traditional dental floss is used.

The principles relating to the design of the preferred embodiment of the current disclosure are a very thin film device with an abiltiy to present a relatively much larger surface area by a system of folds and pleats which can twist, move, and expand. This is a primary method to debride and clean larger interdental and interproximal tooth and gum areas in one pass.

The following is claimed:

1. A thin film drawn between teeth and/or between teeth and gums which exhibits a plurality of folds, pleats, channels, or risers and indention along the longitudinal axis; said device having the characteristics of being able to expand, contract, roll-up onto and/or to collapse upon itself for the purposes of better fitting into and within these areas while cleaning, trapping, holding, snagging, or being used generally for the displacement of particles or debris from within those same interdental areas.

2. A thin film of claim 1 where the folds, pleats, channels, or indentions along the longitudinal axis are stamped, impressed, formed or rolled by mechanical means.

3. The thin film of claim 1 where the folds, pleats, channels, or indentions along the longitudinal axis are formed by chemical or other means.

4. The thin film of claim 1 where the film is additionally mechanically or chemically treated or coated to increase or to enhance certain desirable characteristics such as the hydrophillic properties of the film.

5. A thin film drawn between teeth and/or between teeth and gums which exhibits a plurality of folds, pleats, channels, or indention along the longitudinal axis; said thin film being intended to expand, contract, roll-up onto and/or to collapse upon itself for the purposes of better fitting into and within these areas while being used as a delivery system for topical medications, or for other chemical, physical and/or mechanical treatments.

6. The thin film of claim 1 where the folds, pleats, channels, or risers and indentions are further twisted along that aspect for the length of the device, and where these folds, pleats, channels or indentations gradually curl around the longitudinal axis.
